(19) United States
(12) Patent Application Publication
(10) Pub. No.: US 2026/0300908 A1
(43) Pub. Date: Oct. 1, 2026

(54) TERMINAL DEVICE, PRODUCT MANAGEMENT SYSTEM, PRODUCT MANAGEMENT METHOD, AND PROGRAM

(71) Applicant: Rakuten Group, Inc., Tokyo (JP)

(72) Inventors: Isam NIHOU, Tokyo (JP); Xintian ZHAO, Tokyo (JP); Shima FURUYA, Tokyo (JP)

(73) Assignee: Rakuten Group, Inc., Tokyo (JP)

(21) Appl. No.: 19/571,738

(22) Filed: Mar. 19, 2026

(30) Foreign Application Priority Data
Mar. 27, 2025 (JP) 2025-052893

(51) Int. Cl. G06Q 10/087; G06K 7/14

(52) U.S. Cl. CPC G06Q 10/087; G06K 7/1413

(57) ABSTRACT

The terminal device includes a reading unit that reads a product code from the barcode of a target product; a first determination unit that determines, based on the search results of a substitute code master, whether a first product code read from a first barcode of the target product matches a first determination code stored in the substitute code master; a second determination unit that, when it is determined that the first product code matches the first determination code, determines whether a second product code read from a second barcode of the target product matches a second determination code stored in the substitute code master corresponding to the first determination code; and an issuing unit that issues a management barcode that represents, in a single barcode, the substitute code stored in the substitute code master corresponding to the second determination code.

### BACKGROUND OF THE INVENTION

### Field of the Invention

The present invention relates to a terminal device, a product management system, a product management method, and a program. Priority is claimed on Japanese Patent Application No. 2025-052893, filed on Mar. 27, 2025, the content of which is incorporated herein by reference.

### Description of Related Art

Products being received into a warehouse are registered and managed in an inventory management database by scanning the barcode printed on the product's tag. Generally, one barcode is attached to one product. This barcode records a code value including a product code that can identify the product.

Furthermore, there are cases where a single product is affixed with multiple barcodes (for example, a multi-stage barcode consisting of a combination of an upper stage barcode and a lower stage barcode). Patent Document 1 describes a technology that determines whether a reading device operated by a shopper at a retail store cash register or the like has read a multi-stage barcode attached to a single product or a single-stage barcode attached to each of different products when multiple barcodes are read in a single reading operation.

Patent Document 1: Japanese Unexamined Patent Application Publication No. H07-129701

For example, in warehouses for managing products such as clothing, a barcode reader is used to read barcodes one by one, reading product codes that can identify products from the barcodes printed on the product tags, and managing inventory (receiving and shipping, inventory counting, etc.). In the warehouse, products from multiple brands are also managed. Since each brand may set its own product code, the number of barcodes printed on the tag may also differ for each brand. When multiple barcodes are printed on a tag, since conventional barcode readers that read the barcodes one by one are unable to obtain the correct product code, it impossible in some cases to manage the product using the barcodes on the tag.

Therefore, for products with multiple barcodes printed on the tag, a sticker with a barcode printed on it, including a substitute code (in-house code) for management within the warehouse, was issued in advance, and when the product arrived, a worker had to visually check the barcode printed on the product's tag, find the sticker with the corresponding substitute code printed on it, and affix it to the product (or tag), which was a time-consuming task.

An object of the present invention is to provide a terminal device, a product management system, a product management method, and a program that can easily and appropriately manage products that have multiple barcodes attached to each product.

### SUMMARY OF THE INVENTION

According to one aspect of the present disclosure, a terminal device is provided with: a reading unit that accepts a user's operation and reads a product code from the barcode of a target product being received into a warehouse; a first determination unit that determines, for a product to which multiple barcodes are attached, whether a first product code read from a first barcode of the target product matches a first determination code stored in a substitute code master based on a search result of the substitute code master, which stores, in association with each other, a first determination code represented by one of the barcodes, a second determination code represented by another of the barcodes, and a substitute code for managing the product; and a second determination unit that, when it is determined that the first product code matches the first determination code, determines whether the second product code read from the second barcode of the target product matches the second determination code stored in the substitute code master in correspondence with the first determination code; and an issuing unit that, when it is determined that the second product code matches the second determination code, issues a management barcode that represents, in a single barcode, a substitute code stored in the substitute code master in association with the second determination code.

According to one aspect of the present disclosure, a product management system is provided with: a substitute code master that, for a product to which a plurality of barcodes are attached, stores a first determination code represented by one of the plurality of barcodes, a second determination code represented by another of the plurality of barcodes, and a substitute code for managing the product, in association with each other; and the aforementioned terminal device.

According to one aspect of the present disclosure, a product management system is provided with: a substitute code master that, for a product to which a plurality of barcodes are attached, stores a first determination code represented by one of the plurality of barcodes, a second determination code represented by another of the plurality of barcodes, and a substitute code for managing the product, in association with each other; a product master storing regular product codes of each of a plurality of products; and the aforementioned terminal device.

According to one aspect of the present disclosure, a product management method has: a step of accepting a user's operation and reading a product code from a barcode of a target product being received into a warehouse; a step that determines, for a product to which multiple barcodes are attached, whether a first product code read from a first barcode of the target product matches a first determination code stored in a substitute code master based on a search result of the substitute code master, which stores, in association with each other, a first determination code represented by one of the barcodes, a second determination code represented by another of the barcodes, and a substitute code for managing the product; a step that, when it is determined that the first product code matches the first determination code, determines whether the second product code read from the second barcode of the target product matches the second determination code stored in the substitute code master in correspondence with the first determination code; and a step that, when it is determined that the second product code matches the second determination code, issues a management barcode that represents, in a single barcode, a substitute code stored in the substitute code master in association with the second determination code.

According to one aspect of the present disclosure, a program causes a terminal device to execute: a step that accepts a user's operation and reads a product code from the barcode of a target product being received into a warehouse; a step that determines, for a product to which multiple barcodes are attached, whether a first product code read from a first barcode of the target product matches a first determination code stored in a substitute code master based on a search result of the substitute code master, which stores, in association with each other, a first determination code represented by one of the barcodes, a second determination code represented by another of the barcodes, and a substitute code for managing the product; a step that, when it is determined that the first product code matches the first determination code, determines whether the second product code read from the second barcode of the target product matches the second determination code stored in the substitute code master in correspondence with the first determination code; and a step that, when it is determined that the second product code matches the second determination code, issues a management barcode that represents, in a single barcode, a substitute code stored in the substitute code master in association with the second determination code.

According to the above aspects, it is possible to easily and appropriately manage products to which multiple barcodes are attached.

### BRIEF DESCRIPTION OF THE DRAWINGS

FIG. 1 is a diagram showing the configuration of a product management system according to an embodiment.

FIG. 2 is a flowchart showing an example of a registration process to a master according to an embodiment.

FIG. 3 is a diagram showing an example of a product code list stored in a product master according to an embodiment.

FIG. 4 is a diagram showing an example of a substitute code list stored in a substitute code master according to an embodiment.

FIG. 5 is a flowchart showing an example of processing of a terminal device according to an embodiment.

FIG. 6 is a schematic block diagram showing an example of a computer configuration of a terminal device.

### DETAILED DESCRIPTION OF THE INVENTION

### First Embodiment

Hereinbelow, an embodiment will be described in detail with reference to the drawings.

### Overall Configuration of Product Management System

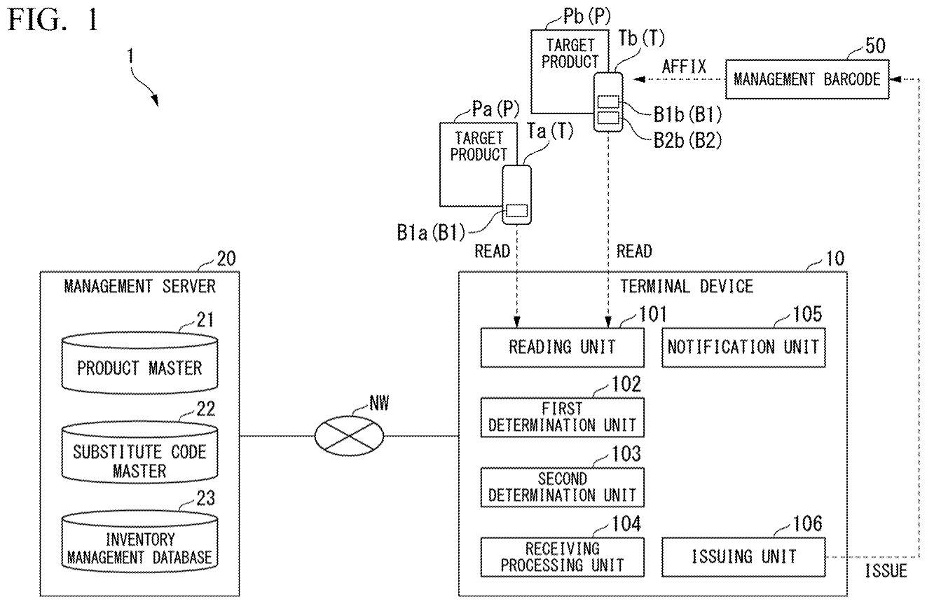

FIG. 1 is a diagram showing the configuration of a product management system according to one embodiment. As shown in FIG. 1, the product management system 1 includes a terminal device 10 and a management server 20.

The terminal device 10 is used by a worker to perform a receiving inspection of a target product P being received into a warehouse where, for example, products such as apparel are handled. The terminal device 10 is an information processing device including a barcode reader that reads the product code of the target product P from a barcode B attached to the target product P.

The barcode B may be printed on a tag T attached to the target product P, or may be attached as a sticker to the package of the target product P, etc. In this embodiment, an example will be described in which the terminal device 10 reads a barcode B printed on the tag T.

The target product P may be attached a tag on which only one barcode printed and a tag on which multiple barcodes B printed. In the example of FIG. 1, only one barcode B1a is printed on a tag Ta of a target product Pa, while two barcodes B1b and B2b are printed across two lines on a tag Tb of a target product Pb. In the following description, the single barcode B1a attached to the target product Pa and the upper barcode B1b among the multiple barcodes attached to the target product Pb will also be referred to as the “first barcode B1.” Furthermore, the lower barcode B2b of the target product Pb will also be referred to as the “second barcode B2.”

Furthermore, although FIG. 1 shows an example in which the first barcode B1b and the second barcode B2b are printed next to each other on the tag Tb, the present invention is not limited thereto. In another embodiment, the first barcode B1b and the second barcode B2b may be printed side by side on the tag Tb. In other words, the arrangement of the first barcode B1b and the second barcode B2b may be set arbitrarily by each brand.

The management server 20 is a server device that is communicably connected to the terminal device 10 via the network NW. The management server 20 includes a product master 21, a substitute code master 22, and an inventory management database 23. The management server 20 stores the product master 21, the substitute code master 22, and the inventory management database 23 in a storage device such as a hard disk. Furthermore, the management server 20 may access the product master 21, the substitute code master 22, and the inventory management database 23 using a processor or the like to search for and record various data.

The product master 21 is a database that stores regular product codes that can identify products managed in the warehouse. The product master 21 is a database owned by, for example, a logistics company that has a warehouse. The regular product code is identification information assigned by each brand (manufacturer, etc.) to each of its products. Regular product codes are set independently by each brand, and may contain a code with more digits than a single barcode can represent. Therefore, some brands divide the official product code into multiple barcodes B and print them on the tag T.

The substitute code master 22 is a database that stores, for products with multiple barcodes B, a first determination code represented by the first barcode B1, a second determination code represented by the second barcode B2, and a substitute code, in association with each other. The substitute code master 22 is a database owned by, for example, a logistics company that has a warehouse. The substitute code is an in-house code set for warehouse management purposes with a number of digits that can be represented by a single barcode.

The inventory management database 23 records the regular product code or substitute code of the target product P, the number of items received into the warehouse, the date of reception, etc.

### Functional Configuration of Terminal Device

As shown in FIG. 1, the terminal device 10 includes a reading unit 101, a first determination unit 102, a second determination unit 103, a receiving processing unit 104, a notification unit 105, and an issuing unit 106.

The reading unit 101 is a barcode reader that accepts an operation by a user (receiving worker) and reads a product code from a barcode B of a target product P that is received into the warehouse. The reading unit 101 may be a barcode reader of any type, such as a CCD type or a laser type.

The first determination unit 102 determines whether the first product code read from the first barcode B1 of the target product P matches the regular product code stored in the product master 21. For example, the first determination unit 102 makes a search request to the management server 20 based on the first product code, and based on the search results, determines whether the first product code read from the first barcode B1 of the target product P matches the regular product code stored in the product master 21. Furthermore, if the read first product code does not match the regular product code, the first determination unit 102 determines whether the first product code matches the first determination code stored in the substitute code master 22. For example, the first determination unit 102 makes a search request to the management server 20 based on the first product code, and based on the search results, determines whether the first product code read from the first barcode B1 of the target product P matches the first determination code stored in the substitute code master 22.

When it is determined that the first product code matches the first determination code registered in the substitute code master 22, the second determination unit 103 determines whether the second product code read from the second barcode B2 of the target product P matches the second determination code stored in the substitute code master 22 in correspondence with the first determination code. For example, the second determination unit 103 makes a search request to the management server 20 based on the second product code, and based on the search results, determines whether the second product code read from the second barcode B2 of the target product P matches the second determination code stored in the substitute code master 22.

The receiving processing unit 104 causes the management server 20 to execute a recording process relating to the reception of the target product P. When it is determined that the first product code of the target product P matches the regular product code, the receiving processing unit 104 causes the management server 20 to record the reception of the target product P based on the regular product code. In addition, when the receiving processing unit 104 determines that the first product code and second product code of the target product P match the first determination code and second determination of the substitute code master 22, it performs a recording process of the reception of the target product P based on the substitute code corresponding to the combination of the first determination code and second determination code. For example, the receiving processing unit 104 records the regular product code or substitute code of the target product P, the number of items received, the reception date, etc in the inventory management database 23.

The notification unit 105 notifies the user of the result of reading the first barcode B1 and prompts the user to perform the next operation. The notification unit 105 may be a lamp (such as an LED) that notifies by light, a speaker that notifies by sound (such as a buzzer) or voice, a display device (such as a liquid crystal display) that notifies by text, or a combination of these. For example, when it is determined that the first product code matches the first determination code of the substitute code master 22, the notification unit 105 notifies the user to read the second barcode B2 of the target product P. In addition, when it is determined that the first product code matches the regular product code in the product master 21, the notification unit 105 may notify the user to read the first barcode B1 of the next target product P.

The issuing unit 106 is a printer that issues a management barcode 50 on which a substitute code for management in the warehouse is printed. The issuing unit 106 may be a printer that prints barcodes in sticker form. When it is determined that the second product code matches the second determination code, the issuing unit 106 issues a management barcode 50 that represents, in one barcode, the substitute code stored in the substitute code master 22 in correspondence with the second determination code. The management barcode 50 is printed on a sticker sheet, and the user affixes the management barcode 50 (sticker) output by the issuing unit 106 to the tag T or package of the target product P. As a result, by simply reading the management barcode 50 of the target product P once in the following processes, it is possible to easily and appropriately carry out tasks such as inventory taking and picking in the warehouse.

### Master Registration Process

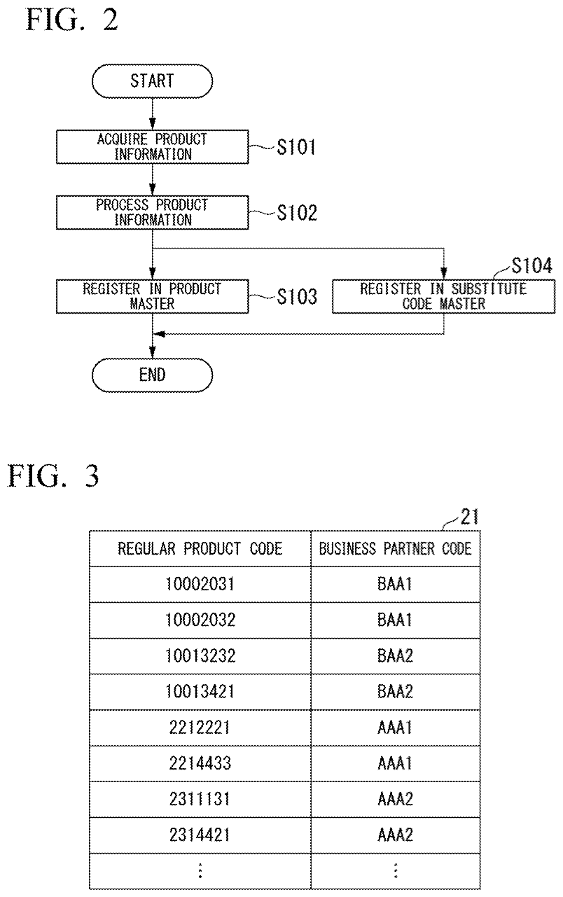

FIG. 2 is a flowchart showing an example of a registration process to a master according to an embodiment. The flow of the process of registering information in the product master 21 and the substitute code master 22 will be described with reference to FIG. 2.

For example, a retailer that purchases and sells products acquires product information about the products that are scheduled to be received into the warehouse from each brand (Step S101). The product information includes the product's regular product code, the code values of each of the multiple barcodes attached to the product (first determination code and second determination code), the product name, color, size, and business partner code that can identify the brand.

Next, the retailer processes the product information acquired from the brand (Step S102) and registers the product information in the product master 21 and the substitute code master 22 of the management server 20 (steps S103 to S104).

FIG. 3 is a diagram showing an example of a product code list stored in the product master according to an embodiment. As shown in FIG. 3, the product master 21 stores the regular product code of each product. When the retailer acquires product information from each brand (Step S101), the retailer extracts and processes only the necessary information from the product information (Step S102), and registers it in the product master 21 (Step S103). FIG. 3 shows an example in which the retailer extracts a regular product code and a business partner code from product information in steps S102 and S103 and registers them in the product master 21. In other embodiments, other information included in the product information (for example, product name, color, size, etc.) may be further registered in the product master 21.

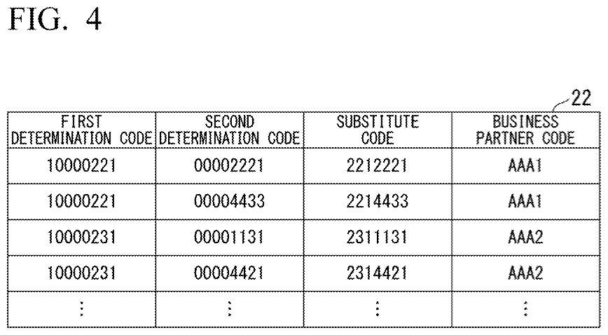

FIG. 4 is a diagram showing an example of a substitute code list stored in the substitute code master according to an embodiment. As shown in FIG. 4, the substitute code master 22 stores the first determination code represented by the first barcode B1 of each product, the second determination code represented by the second barcode B2, and a substitute code for managing the product in the warehouse, in association with each other. When the retailer acquires product information from each brand (Step S101), it extracts and processes only the necessary information from the product information (Step S102), and registers it in the substitute code master 22 (Step S104). FIG. 4 shows an example in which the retailer extracts the first determination code, the second determination code, and the business partner code from the product information in steps S102 and S104, and registers them in the substitute code master 22. In Step S104, the management server 20 automatically generates a substitute code from information input by the retailer (for example, the first determination code and the second determination code) in accordance with a predetermined rule, and registers the substitute code in the substitute code master 22. The substitute code may be manually generated and registered later by the distributor in accordance with predetermined rules. In another embodiment, other information included in the product information (for example, a regular product code) may be further registered in the substitute code master 22. Although FIG. 4 shows an example in which numbers are used as substitution codes, the present invention is not limited thereto. The substitute code may include letters or symbols instead of or in addition to numbers.

### Example of Terminal Device Processing

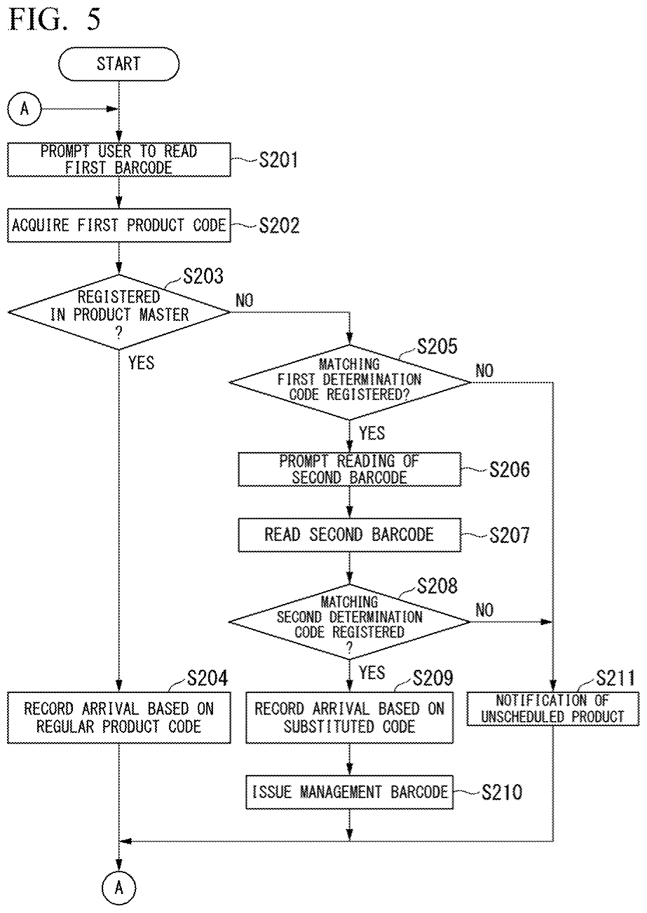

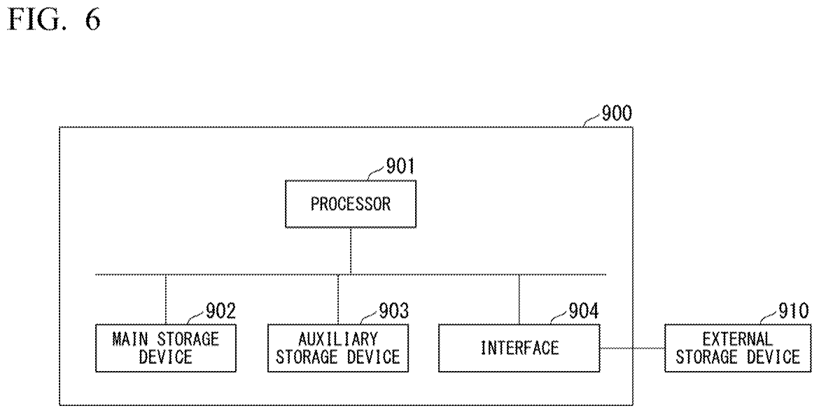

FIG. 5 is a flowchart showing an example of the processing of a terminal device according to an embodiment. The flow of processing by the terminal device 10 will be described with reference to FIG. 5.

A user (a warehouse receiving worker) uses the terminal device 10 to perform a receiving inspection of a product (target product P) that has been received into the warehouse. First, when the user starts up the terminal device 10, the notification unit 105 outputs a notification prompting the user to read the first barcode B1 of the target product P (Step S201).

The reading unit 101 accepts the user's operation, reads the first barcode B1 printed on the tag T of the target product P, and acquires the first product code (Step S202).

Next, the first determination unit 102 determines whether a regular product code that matches the first product code read from the first barcode B1 is registered in the product master 21 (Step S203).

For example, suppose that the reading unit 101 reads the first barcode B1a printed on the tag Ta of the target product Pa (FIG. 1). The target product Pa has only the first barcode B1a, and the first product code represented by this first barcode B1a is the regular product code of the target product Pa. The first determination unit 102 sends a search request to the management server 20 using the first product code as a key. The management server 20 searches the product master 21 based on the key, and transmits the search results to the terminal device 10 (first determination unit 102). The first determination unit 102 refers to the search results received from the management server 20, and if a regular product code that matches the first product code read from the first barcode B1a is registered in the product master 21 (Step S203: YES), it obtains this regular product code from the product master 21 and outputs it to the receiving processing unit 104.

Then, the receiving processing unit 104 requests the management server 20 to record the reception of the target product Pa based on the regular product code output from the first determination unit 102. Then, in response to the request, the management server 20 records information related to the request in the inventory management database 23 (Step S204). For example, the receiving processing unit 104 sends a reception record request to the management server 20 including the regular product code and the reception date. The management server 20 records information related to the request in the inventory management database 23. The management server 20 may aggregate records (reception records) that have the same regular product code and reception date and record the aggregated information as the number of items received. The reception record may also be different for each user. In this case, the terminal device 10 transmits the user ID stored in advance to the management server 20 when making a reception record request. At this time, the notification unit 105 may also notify the user that the reception of the target product Pa has been recorded. Thereafter, the terminal device 10 returns to Step S201 and waits for the processing of the next target product P.

It is assumed, for example, that the reading unit 101 reads the first barcode B1b on the tag Tb of the target product Pb (FIG. 1). The target product Pb has a first barcode B1b and a second barcode B2b, and the first product code represented by the first barcode B1b is different from the regular product code of the target product Pb. The first determination unit 102 requests the management server 20 to search the product master 21 using the first product code as a key, and if the management server 20 searches the product master 21 based on the key and finds that the product master 21 does not contain a regular product code that matches the first product code read from the first barcode B1b (Step S203: NO), the management server 20 further searches the substitute code master 22 using the first product code as a key. Then, the management server 20 determines whether a first determination code that matches the first product code is registered in the substitute code master 22, and transmits the result to the terminal device 10 (Step S205).

When the management server 20 searches the substitute code master 22 in response to a search request and finds that no first determination code matching the first product code read from the first barcode B1b is registered in the substitute code master 22 (Step S205: NO), that is, when the search result from the management server 20 returns zero records, the first determination unit 102 determines that the target product Pb is an unscheduled product not registered in either the product master 21 or the substitute code master 22. In this case, for example, the notification unit 105 notifies the user that the product is not registered in the management server 20 (unscheduled product) (Step S211), and the process returns to Step S201. Upon receiving this notification, the user reports to the retailer that the target product Pb, which is an unscheduled product, has been received. Furthermore, for example, if the user mistakenly reads the second barcode B2 of the target product Pb first, the user is notified that the second barcode B2 does not match the first determination code and is therefore an unscheduled product. In this case, the terminal device 10 also returns to Step S201, and the user, upon receiving the notification in Step S201, can simply read the first barcode B1b of the target product Pb again.

On the other hand, if the search results obtained from the management server 20 indicate that a first determination code that matches the first product code read from the first barcode B1b is registered in the substitute code master 22 (Step S205: YES), the first determination unit 102 determines that the target product Pb has a second barcode B2. In this case, the notification unit 105 outputs a notification prompting the user to read the second barcode B2 (Step S206).

The reading unit 101 accepts the user's operation, reads the second barcode B2b printed on the tag Tb of the target product Pb, and acquires the second product code (Step S207).

Next, the second determination unit 103 makes a search request to the management server 20 for the substitute code master 22 using the second product code read from the second barcode B2b as a key, and by referring to the results of the search request, determines whether a second determination code matching the second product code is registered in the substitute code master 22 (Step S208). At this time, in Step S205, the records stored in the substitute code master 22 are narrowed down to those having the first determination code that matches the first product code. Based on a search request from the terminal device 10 (second determination unit 103), the management server 20 searches these narrowed-down records for records having a second determination code that matches the second product code, and transmits the search results to the terminal device 10.

The second determination unit 103 makes a search request to the management server 20 using the second product code as a key, obtains the results of the management server 20 searching the substitute code master 22 based on the key, and if the search results indicate that there is no record having a second determination code that matches the second product code read from the second barcode B2b (Step S208: NO), that is, if the search result is zero, it determines the target product Pb to be an unscheduled product that is not registered in the product master 21 or the substitute code master 22. In this case, for example, the notification unit 105 notifies the user that the product is not registered in the management server 20 (unscheduled product) (Step S211), and the process returns to Step S201.

On the other hand, the second determination unit 103 makes a search request to the management server 20 using the second product code as a key, obtains the results of the management server 20 searching the substitute code master 22 based on the key, and if the search results indicate that a record having a second determination code that matches the second product code read from the second barcode B2b exists (Step S208: YES), that is, the search result includes the above-mentioned record, the second determination unit 103 reads out the substitute code included in this record and outputs it to the receiving processing unit 104 and the issuing unit 106. In addition, if the second determination unit 103 receives only an indication that a record exists as a result of the search by the management server 20, it may again request the contents of the record from the management server 20 and read out the substitute code contained in the record.

Then, the receiving processing unit 104 requests the management server 20 to record the reception of the target product Pb based on the substitute code output from the second determination unit 103. Then, in response to the request, the management server 20 records information related to the request in the inventory management database 23 (Step S209). For example, the receiving processing unit 104 causes the management server 20 to record the substitute code, the number of items received, the reception date, etc. in the inventory management database 23.

The issuing unit 106 issues a management barcode 50 on which a barcode representing the substitute code output from the second determining unit 103 is printed (Step S210). The user attaches the management barcode 50 issued by the issuing unit 106 to, for example, a tag Tb of the target product Pb. As a result, by simply reading the management barcode 50 of the target product P once in the following processes, it is possible to easily and appropriately carry out tasks such as inventory counting and picking in the warehouse. The notification unit 105 may also notify the user that the arrival of the target product Pb has been recorded. Thereafter, the terminal device 10 returns to Step S201 and waits for the processing of the next target product P.

By repeatedly executing the series of processes shown in FIG. 5, the terminal device 10 can record the reception into inventory of each target product P being received into the warehouse and issue a management barcode 50 as necessary.

### Computer Configuration

FIG. 6 is a schematic block diagram showing an example of the computer configuration of the terminal device. The computer 900 includes a processor 901, a main storage device 902, an auxiliary storage device 903, and an interface 904. The above-described terminal device 10 is implemented in the computer 900. The operations of the above-described processing units of the terminal device 10 are stored in the auxiliary storage device 903 in the form of a program. The processor 901 reads the program from the auxiliary storage device 903, loads it into the main storage device 902, and executes the above-mentioned processing in accordance with the program. Furthermore, the processor 901 allocates a storage area in the main storage device 902 to be used in the above processing in accordance with the program.

The program may be for realizing some of the functions that the computer 900 performs. For example, the program may be a so-called differential file (differential program) that can realize the aforementioned functions in combination with another program already stored in the auxiliary storage device 903 or with other programs implemented in other devices.

Examples of the auxiliary storage device 903 include a hard disk drive (HDD), a solid state drive (SSD), a magnetic disk, a magneto-optical disk, a compact disc read only memory (CD-ROM), a digital versatile disc read only memory (DVD-ROM), and a semiconductor memory. The auxiliary storage device 903 may be an internal medium directly connected to the bus of the computer 900, or may be an external medium (external storage device 910) connected to the computer 900 via the interface 904 or a communication line. Furthermore, when this program is distributed to the computer 900 via a communication line, the computer 900 that receives the program may load the program into the main storage device 902 and execute the above processing. In at least one embodiment, the auxiliary storage device 903 is a non-transitory tangible storage medium.

The computer 900 may also have an input/output device (not shown). The input/output device includes means for accepting user operations (power button, selection button, etc.), a display, a lamp, and a speaker that function as the notification unit 105 described above. The input/output device also includes a printer functioning as the issuing unit 106 and a barcode reader functioning as the reading unit 101.

The hardware configuration of the management server 20 may also be the same as that of the computer 900.

### Action and Effect

As described above, the terminal device 10 according to the present embodiment comprises: a reading unit 101 that reads a product code from a barcode B of a target product P being received into a warehouse in response to a user operation; a first determination unit 102 that determines, based on the search results of the substitute code master 22, whether the first product code read from the first barcode B1 of the target product P matches the first determination code stored in the substitute code master 22; a second determination unit 103 that, when it is determined that the first product code matches the first determination code, determines whether the second product code read from the second barcode B2 of the target product P matches the second determination code stored in the substitute code master 22 in correspondence with the first determination code; and an issuing unit 106 that, when it is determined that the second product code matches the second determination code, issues the management barcode 50 in which the substitute code stored in the substitute code master 22 in correspondence with the second determination code is represented by a single barcode.

In this way, the terminal device 10 can read the multiple barcodes B1, B2 attached to the target product P, obtain the corresponding substitute codes from the substitute code master 22, and issue the management barcode 50 that is a single barcode. By affixing this management barcode 50 to the target product P, and then by simply reading the management barcode 50 of the target product P once, the user can easily and appropriately perform tasks such as inventory counting and picking in the warehouse.

The terminal device 10 further includes a notification unit 105 that prompts the user to read the second barcode B2 when the first product code matches the first determination code stored in the substitute code master 22.

In this way, after reading the first barcode B1, the terminal device 10 can prompt the user to perform the next operation, which is to read the second barcode B2. This allows the user to perform a reception inspection of the target product P without any confusion about the operation procedure.

In addition, based on the search results of the product master 21, if the first product code read from the first barcode B1 does not match the regular product code stored in the product master 21, the first determination unit 102 determines whether the first product code matches the first determination code stored in the substitute code master 22.

By doing this, the terminal device 10 can determine, based on the search results of the product master 21, whether the target product P has only one barcode B (only the first barcode B1) attached thereto, or whether the target product P has multiple barcodes B (the first barcode B1 and the second barcode B2) attached thereto.

In addition, the terminal device 10 further includes the receiving processing unit 104 that records the reception into inventory of the target product P, and when it is determined that the first product code matches the regular product code stored in the product master 21, the receiving processing unit 104 records the reception into inventory of the target product P based on the regular product code.

By doing this, the terminal device 10 can record the reception into inventory of a target product P that has only one barcode B (only the first barcode B1) attached thereto based on the regular product code, simply by the user performing the operation of reading the first barcode B1 once.

Furthermore, when the receiving processing unit 104 determines that the first product code does not match the regular product code stored in the product master 21 and that the first product code and the second product code match the first determination code and the second determination code stored in the substitute code master 22, it records the reception into inventory of the target product P based on the substitute code stored in the substitute code master 22 corresponding to the first determination code and the second determination code.

By doing this, the terminal device 10 can record the reception into inventory of a target product P that has multiple barcodes B (first barcode B1 and second barcode B2) attached thereto based on the substitute code simply by the user performing the operation of reading the first barcode B1 and the second barcode B2 in sequence.

### Other Embodiments

Although one embodiment has been described in detail above with reference to the drawings, the specific configuration is not limited to that described above, and various design modifications and the like are possible. That is, in other embodiments, the order of the above-described processes may be changed as appropriate. Furthermore, some of the processes may be executed in parallel.

For example, in the above embodiment, an example was described in which the target product Pb has two barcodes, a first barcode B1b and a second barcode B2b, affixed thereto, but the present invention is not limited thereto. In other embodiments, two or more second barcodes B2b may be affixed to the target product Pb. That is, a total of three or more barcodes B may be affixed to one target product P.

In this case, a plurality of second determination codes are registered in the substitute code master 22 shown in FIG. 4. Furthermore, the second determination unit 103, by referring to the records retrieved for in Step S208, determines that another second barcode B2 exists for the target product Pb. In this case, the terminal device 10 repeats the processes of steps S206 to S208 once again to search for a record that matches the combination of the first product code and a plurality of second product codes.

In this way, even for a target product P with three or more barcodes affixed, it is possible to record the reception into inventory and issue the management barcode 50.

Some or all of the above embodiments can be described as, but are not limited to, the following supplementary notes.

### Supplementary Note 1

A terminal device provided with: a reading unit that accepts a user's operation and reads a product code from the barcode of a target product being received into a warehouse; a first determination unit that determines, for a product to which multiple barcodes are attached, whether a first product code read from a first barcode of the target product matches a first determination code stored in a substitute code master based on a search result of the substitute code master, which stores, in association with each other, a first determination code represented by one of the barcodes, a second determination code represented by another of the barcodes, and a substitute code for managing the product; and a second determination unit that, when it is determined that the first product code matches the first determination code, determines whether the second product code read from the second barcode of the target product matches the second determination code stored in the substitute code master in correspondence with the first determination code; and an issuing unit that, when it is determined that the second product code matches the second determination code, issues a management barcode that represents, in a single barcode, a substitute code stored in the substitute code master in association with the second determination code.

### Supplementary Note 2

The terminal device according to Supplementary Note 1, further provided with: a notification unit that prompts the user to read the second barcode when the first product code matches the first determination code stored in the substitute code master.

### Supplementary Note 3

The terminal device according to Supplementary Note 1 or 2, wherein the first determination unit, based on a search result of a product master storing regular product codes of each of a plurality of products, determines whether the first product code read from the first barcode matches the first determination code stored in the substitute code master when the first product code does not match the regular product code stored in the product master.

### Supplementary Note 4

The terminal device according to Supplementary Note 3, further comprising a receiving processing unit that records the reception into inventory of the target product, wherein the receiving processing unit, when it is determined that the first product code matches the regular product code stored in the product master, records the reception into inventory of the target product based on the regular product code.

### Supplementary Note 5

The terminal device according to Supplementary Note 4, wherein the receiving processing unit, when it is determined that the first product code does not match the regular product code stored in the product master, and that the first product code and the second product code match the first determination code and the second determination code stored in the substitute code master, records the reception into inventory of the target product based on the substitute code stored in the substitute code master in correspondence with the first determination code and the second determination code.

### Supplementary Note 6

A product management system comprising: a substitute code master that, for a product to which a plurality of barcodes are attached, stores a first determination code represented by one of the plurality of barcodes, a second determination code represented by another of the plurality of barcodes, and a substitute code for managing the product, in association with each other; and the terminal device according to Supplementary Note 1or 2.

### Supplementary Note 7

A product management system comprising: a substitute code master that, for a product to which a plurality of barcodes are attached, stores a first determination code represented by one of the plurality of barcodes, a second determination code represented by another of the plurality of barcodes, and a substitute code for managing the product, in association with each other; and
a product master storing regular product codes of each of a plurality of products; and the terminal device according to any one of supplementary notes 3 to 5.

### Supplementary Note 8

A product management method comprising: a step of accepting a user's operation and reading a product code from a barcode of a target product being received into a warehouse; a step that determines, for a product to which multiple barcodes are attached, whether a first product code read from a first barcode of the target product matches a first determination code stored in a substitute code master based on a search result of the substitute code master, which stores, in association with each other, a first determination code represented by one of the barcodes, a second determination code represented by another of the barcodes, and a substitute code for managing the product; a step that, when it is determined that the first product code matches the first determination code, determines whether the second product code read from the second barcode of the target product matches the second determination code stored in the substitute code master in correspondence with the first determination code; and a step that, when it is determined that the second product code matches the second determination code, issues a management barcode that represents, in a single barcode, a substitute code stored in the substitute code master in association with the second determination code.

### Supplementary Note 9

A program that causes a terminal device to execute: a step that accepts a user's operation and reads a product code from the barcode of a target product being received into a warehouse; a step that determines, for a product to which multiple barcodes are attached, whether a first product code read from a first barcode of the target product matches a first determination code stored in a substitute code master based on a search result of the substitute code master, which stores, in association with each other, a first determination code represented by one of the barcodes, a second determination code represented by another of the barcodes, and a substitute code for managing the product; a step that, when it is determined that the first product code matches the first determination code, determines whether the second product code read from the second barcode of the target product matches the second determination code stored in the substitute code master in correspondence with the first determination code; and a step that, when it is determined that the second product code matches the second determination code, issues a management barcode that represents, in a single barcode, a substitute code stored in the substitute code master in association with the second determination code.

### REFERENCE SIGNS LIST

1 Product management system
10 Terminal device
101 Reading unit
102 First determination unit
103 Second determination unit
104 Receiving processing unit
105 Notification unit
106 Issuing unit
20 Management server
21 Product master
22 Substitute code master
23 Inventory management database
50 Management barcode

What is claimed is:

1. A terminal device comprising:
a reading unit that accepts a user's operation and reads a product code from the barcode of a target product being received into a warehouse;
a first determination unit that determines, for a product to which multiple barcodes are attached, whether a first product code read from a first barcode of the target product matches a first determination code stored in a substitute code master based on a search result of the substitute code master, which stores, in association with each other, a first determination code represented by one of the barcodes, a second determination code represented by another of the barcodes, and a substitute code for managing the product; and
a second determination unit that, when it is determined that the first product code matches the first determination code, determines whether the second product code read from the second barcode of the target product matches the second determination code stored in the substitute code master in correspondence with the first determination code; and
an issuing unit that, when it is determined that the second product code matches the second determination code, issues a management barcode that represents, in a single barcode, a substitute code stored in the substitute code master in association with the second determination code.

2. The terminal device according to claim 1, further comprising:
a notification unit that prompts the user to read the second barcode when the first product code matches the first determination code stored in the substitute code master.

3. The terminal device according to claim 1,
wherein the first determination unit, based on a search result of a product master storing regular product codes of each of a plurality of products, determines whether the first product code read from the first barcode matches the first determination code stored in the substitute code master when the first product code does not match the regular product code stored in the product master.

4. The terminal device according to claim 3,
further comprising a receiving processing unit that records the reception into inventory of the target product,
wherein the receiving processing unit, when it is determined that the first product code matches the regular product code stored in the product master, records the reception into inventory of the target product based on the regular product code.

5. The terminal device according to claim 4,
wherein the receiving processing unit, when it is determined that the first product code does not match the regular product code stored in the product master, and that the first product code and the second product code match the first determination code and the second determination code stored in the substitute code master, records the reception into inventory of the target product based on the substitute code stored in the substitute code master in correspondence with the first determination code and the second determination code.

6. A product management system comprising:
a substitute code master that, for a product to which a plurality of barcodes are attached, stores a first determination code represented by one of the plurality of barcodes, a second determination code represented by another of the plurality of barcodes, and a substitute code for managing the product, in association with each other; and
the terminal device according to claim 1.

7. A product management system comprising:
a substitute code master that, for a product to which a plurality of barcodes are attached, stores a first determination code represented by one of the plurality of barcodes, a second determination code represented by another of the plurality of barcodes, and a substitute code for managing the product, in association with each other; and
a product master storing regular product codes of each of a plurality of products; and
the terminal device according to claim 3.

8. A product management method comprising:
a step of accepting a user's operation and reading a product code from a barcode of a target product being received into a warehouse;
a step that determines, for a product to which multiple barcodes are attached, whether a first product code read from a first barcode of the target product matches a first determination code stored in a substitute code master based on a search result of the substitute code master, which stores, in association with each other, a first determination code represented by one of the barcodes, a second determination code represented by another of the barcodes, and a substitute code for managing the product;
a step that, when it is determined that the first product code matches the first determination code, determines whether the second product code read from the second barcode of the target product matches the second determination code stored in the substitute code master in correspondence with the first determination code; and a step that, when it is determined that the second product code matches the second determination code, issues a management barcode that represents, in a single barcode, a substitute code stored in the substitute code master in association with the second determination code.

9. A non-transitory computer readable medium that records a program that causes a terminal device to execute:
a step that accepts a user's operation and reads a product code from the barcode of a target product being received into a warehouse;
a step that determines, for a product to which multiple barcodes are attached, whether a first product code read from a first barcode of the target product matches a first determination code stored in a substitute code master based on a search result of the substitute code master, which stores, in association with each other, a first determination code represented by one of the barcodes, a second determination code represented by another of the barcodes, and a substitute code for managing the product;
a step that, when it is determined that the first product code matches the first determination code, determines whether the second product code read from the second barcode of the target product matches the second determination code stored in the substitute code master in correspondence with the first determination code; and a step that, when it is determined that the second product code matches the second determination code, issues a management barcode that represents, in a single barcode, a substitute code stored in the substitute code master in association with the second determination code.
